(19) United States
(12) Patent Application Publication
(10) Pub. No.: US 2008/0071843 A1
(43) Pub. Date: Mar. 20, 2008

(54) Systems and methods for indexing and visualization of high-dimensional data via dimension reorderings

(76) Inventors: Spyridon Papadimitriou, White Plains, NY (US); Zografoula Vagena, San Jose, CA (US); Michail Vlachos, Tarrytown, NY (US); Philip Shi-lung Yu, Chappaqua, NY (US)

Correspondence Address: KEUSEY, TUTUNJIAN & BITETTO, P.C., 20 CROSSWAYS PARK NORTH, SUITE 210, WOODBURY, NY, 11797, US

(21) Appl. No.: 11/521,141

(22) Filed: Sep. 14, 2006

(51) Int. Cl. G06F 17/30

(52) U.S. Cl. 707/204

(57) ABSTRACT

Systems and methods for reordering dimensions of a multiple-dimensional dataset includes ordering dimensions of multi-dimensional dataset such that original D dimensions of the data are reordered to obtain a smooth sequence representation which includes placement of the D dimensions with similar behavior at adjacent positions in an ordered sequence representation. The ordered sequence representation is segmented into groups of K<D dimensions for placement in a K-dimensional indexing structure.

### BACKGROUND

1. Technical Field

The present invention relates to mapping high-dimensional data onto fewer dimensions, and more particularly to systems and methods for reordering the original dimensions, so that dimensions with similar behavior are placed at adjacent positions after reordering.

2. Description of the Related Art

Performing searches in high-dimensional data sets is typically inefficient and difficult. For searches on a set of high-dimensional data, suppose for simplicity that the data lie in a unit hypercube C=[0, 1]^{D}, where D is the data dimensionality. Given a query point, the probability P_{w} that a match (neighbor) exists within radius w in the data space of dimensionality D is given by P_{w}(D)=w^{D}, which decreases exponentially with respect to D. In other words, at higher dimensionalities the data becomes very sparse and, even at large radii, only a small portion of the entire space is covered. This is also known as the “dimensionality curse”, which in simple terms translates into the following fact: for large dimensionalities existing indexing structures outperform sequential scan only when the dataset size (number of objects) grows exponentially with respect to dimensionality.

Thus, there is clear need for a mapping from high-dimensional to low-dimensional spaces that will boost the performance of traditional indexing structures (such as R-trees) without changing their inner-workings, structure or search strategy.

Traditional clustering approaches, such as K-means, K-medoids or hierarchical clustering focus on finding groups of similar values and not on finding a smooth ordering. In the related fields of co-clustering, bi-clustering, subspace clustering and graph partitioning, the problem of finding pattern similarities has been explored. For example, techniques such as minimizing pairwise differences, both among dimensions as well as among tuples have been attempted. In general, these approaches focus on clustering both rows and columns and treat the rows and columns symmetrically. Most of these approaches are not suitable for large-scale databases with millions of tuples.

Other techniques propose a vertical partitioning scheme for nearest neighbor query processing, which considers columns in order of decreasing variance. However, these techniques do not provide any grouping of the dimensions, and hence are not suitable for visualization or indexing.

Dimension reordering techniques are typically interested in minimizing visual clutter. Furthermore, they do not consider grouping of attributes nor do they address indexing issues.

In the area of high-dimensional visualization, the FASTMAP technique for dimensionality reduction and visualization has been presented. However, this method does not provide any bounds on the distance in the low-dimensional space, and therefore cannot guarantee a “no false dismissals” claim.

### SUMMARY

Present principles are partially inspired by or adapted from concepts in parallel coordinates visualization, time-series representation, co-clustering and bi-clustering methodologies. However, in accordance with the systems and methods presented herein, one of the differences from these techniques is the focus is on indexing and visualization of high-dimensional data. Note, however, that since the present principles rely on the efficient grouping of correlated/co-regulated attributes, some of these techniques can also be utilized, e.g., for the identification of the principal data axes for high-dimensional datasets. Also, the column reordering problem for binary matrices, which is a special case of the desired reordering for the present embodiments is already shown to be NP-hard, as will be explained herein.

In accordance with present principles, an asymmetry (N<<D) is assumed which makes the solution quite different from the prior techniques. In addition, a cost objective in accordance with present principles is not related to the per-column variance. While the present dimension summarization technique bares resemblances to the piecewise aggregate approximation (PAA) and segment means, the present principles are more general and permit segments of unequal size. Additionally, the techniques are predicated on the smoothness assumption of time-series data.

The present principles can make a “no false dismissals” claim that is provided by a lower-bounding criterion. The data representation in accordance with present principles makes visualizations more coherent and useful, not only because the representation is smoother, but because it also performs the additional steps of dimension grouping and summarization.

The present principles apply the following transformations: i) conceptually, treat high-dimensional data as ordered sequences (dimensions). ii) the original D dimensions will be reordered to obtain a globally smooth sequence representation. This will lead to placement of dimensions with similar behavior at adjacent positions in the ordered representation as sequence. iii) The resulting sequences will be segmented or partitioned into groups of K<D dimensions which can be then stored in a K-dimensional indexing structure. iv) Additionally, the objects using the ordered dimensions can be meaningfully visualized as a time-series.

The above is achieved by performing a single pass over the dataset to collect global statistics, and in one example, an appropriate ordering of the dimensions is discovered by recasting the problem as an instance of the well-studied TSP (traveling salesman problem).

A system and method for reordering dimensions of a multiple-dimensional dataset includes ordering dimensions of multi-dimensional dataset such that original D dimensions of the data are reordered to obtain a smooth sequence representation which includes placement of the D dimensions with similar behavior at adjacent positions in an ordered sequence representation. The ordered sequence representation is segmented into groups of K<D dimensions (e.g., for placement in a K-dimensional indexing structure) based on a break point criterion.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 shows probability curves showing a probability that a match exists for a query in a radius w;

FIG. 2 is a diagram showing a reordering and indexing system and method in accordance with an illustrative embodiment;

FIG. 3 is a mapping of 25 dimension image features onto two dimensions and showing correspondence between projected and original dimensions;

FIG. 4 shows a reordering of data with the selection of partitions in accordance with an illustrative embodiment;

FIG. 5 shows an ordered volume for one data point within a segment where the points of the left are non-optimally ordered and the points on the right are optimally ordered;

FIG. 6 shows one point and two total ordered that correspond to a same partitioning, partition sizes and breakpoints are also shown;

FIG. 7 is a diagram showing a traveling salesman problem (TSP) tour which may be employed to determine dimension distances and breakpoints for partitioning (segmenting) in accordance with an illustrative embodiment;

FIG. 8 is a block/flow diagram for employing TSP for reordering and portioning in accordance with an illustrative embodiment;

FIG. 9 is an example of an R-tree structure which can be employed as an indexing structure in accordance with one embodiment;

FIG. 10A shows a method for extraction of features from an image for sequence mapping in accordance with one illustrative embodiment;

FIG. 10B shows a method for mapping extracted image features as sequences in accordance with one illustrative embodiment;

FIG. 11A is a diagram showing image data after reordering in accordance with present principles;

FIG. 11B is a diagram showing image data after reordering and averaging in accordance with present principles;

FIG. 12 is a 2D image mapping showing how reduced dimensionality data can be mapped and visualized to provide useful information;

FIG. 13 is a mapping of 25 dimension image features onto two dimensions similar to FIG. 3 but showing additional dimensionality; and

FIG. 14 is a chart showing savings provided by using projected grouping methods in accordance with the present principles for an R-tree structure.

### DETAILED DESCRIPTION OF PREFERRED EMBODIMENTS

A new representation for high-dimensional data is provided that can prove very effective for visualization, nearest neighbor (NN) and range searches. It has been demonstrated that existing index structures cannot facilitate efficient searches in high-dimensional spaces. A transformation from points to sequences in accordance with the present principles can po-tentially diminish the negative effects of the “dimensionality curse”, permitting an efficient NN-search. The transformed sequences are optimally reordered, segmented and stored in a low-dimensional index. Experimental results validate that the representation in accordance with the present principles can be a useful tool for the fast analysis and visualization of high-dimensional databases.

In illustrative embodiments, a database including N tuples each with D dimensions (or attributes) is related to reordering the original dimensions, so that dimensions with similar behavior are placed at adjacent positions after reordering. Subsequently, the reordered dimensions are partitioned into K<D groups, such that the dimensions most similar to each other are placed in the same group. Finally, the values of each tuple within each group of dimensions are summarized with a single number, thus providing a mapping from the original D-dimensional space into a smaller K-dimensional space.

The present principles are also related to providing guarantees on the pairwise object distances in the smaller space, so that the low dimensional space can be used in conjunction with existing indexing structures (such as R-trees) for mitigating the adverse effect of high dimensionality on index search performance. Related to identification of the principal data axes for high-dimensional datasets, the present principles rely on the efficient grouping of correlated/co-regulated attributes.

Embodiments of the present invention can take the form of an entirely hardware embodiment, an entirely software embodiment or an embodiment including both hardware and software elements. In a preferred embodiment, the present invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that may include, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

In performing search operations on a set of high-dimensional data, assume that the data lie in a unit hypercube C=[0, 1]^{d}, where d is the data dimensionality. Given a query point, the probability P_{w} that a match (neighbor) exists within radius w in the data space of dimensionality d is given by P_{w}(d)=w^{d}.

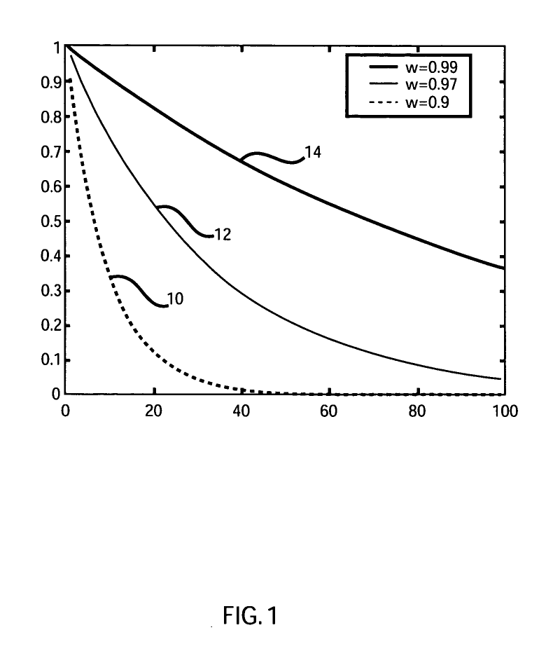

Referring now to the drawings in which like numerals represent the same or similar elements and initially to FIG. 1, a probability for various values of w are shown. Curve 10 shows w=0.90, curve 12 shows w=0.97, and curve 14 shows w=0.99. Evidently, at higher dimensionalities the data becomes very sparse and even at large radii, only a small portion of the entire space is covered. This is also known as the “dimensionality curse”, which translates into the following. For large dimensionalities existing indexing structures outperform sequential scan only when the dataset size (number of objects) grows exponentially with respect to dimensionality.

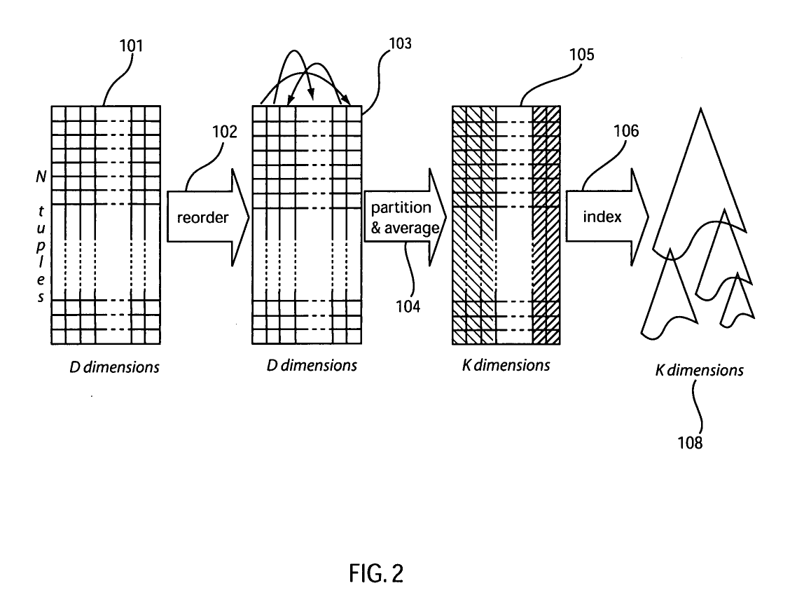

Referring to FIG. 2, a mapping system and method are schematically depicted for high-dimensional to low-dimensional spaces to boost the performance of traditional indexing structures, such as R-trees, without changing their inner-workings, structure or search strategy. The mapping provided in accordance with present principles condenses sparse/unused data space by grouping and indexing together dimensions that share similar characteristics. This is performed by applying a reorder transformation 102 to a high-dimensional dataset 101. The high-dimensional data 101 will be treated as ordered sequences or ordered dimensions. The original D dimensions will are reordered to obtain a globally smooth sequence representation 103. This will lead to the placement of dimensions with similar behavior at adjacent positions in the ordered representation 103 as sequences. A partition and average transformation 104 is performed such that the resulting sequences 105 will be segmented into groups of K<D dimensions. Averaging may be employed to summarize dimensions (e.g., representing a dimension by computing an average or other representative number). Using an indexing method 106, these groups of K<D dimensions 105 can be then stored in a K dimensional indexing structure 108.

The present principles focus on the indexing of high-dimensional data. The approach may include relying on efficient groupings of correlated/co-regulated attributes, which may be obtained through one or more of the following techniques: parallel coordinates visualization, time-series representation, co-clustering and bi-clustering methodologies, etc. These algorithms may also he utilized for the identification of the principal data axes for high-dimensional datasets.

Therefore, embodiments in accordance with present principles: (i) provide an efficient abstraction that can map high dimensional datasets into a low-dimensional space. (ii) The new space can be used to visualize the data in two (or three) dimensions. (iii) The low dimensional space can be used in conjunction with existing indexing structures (such as R-trees) for mitigating the adverse effect of high-dimensionality on the index search performance. (iv) The data mapping effectively organizes the data features into logical subsets. This readily permits for efficient determination of correlated or co-regulated data features. These features will be described in greater detail below.

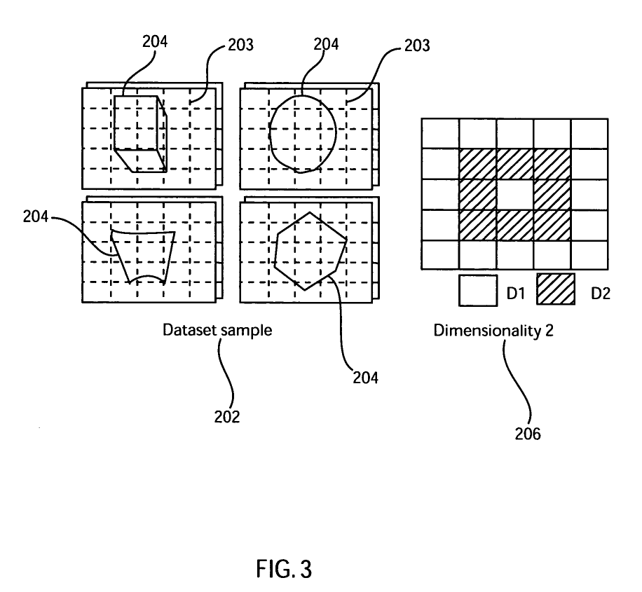

Referring to FIG. 3, a sample mapping of 25-dimensional image features onto 2 dimensions and the correspondence of projected dimensions against original dimensions is illustratively shown. An example of the dimension grouping and dimensionality reduction achieved by present principles is illustratively shown. A dataset sample 202 includes 25-dimensional features extracted from multiple images using a 5×5 grid 203 . Each image 204 belongs to one of the following four shape classes: cube, ellipse, hexagon and trapezoid. The shapes are drawn by humans, so they exhibit dislocations or distortions and no two images are identical.

Using the low dimensional projection/grouping in accordance with the present principles, each 25-dimensional point was mapped onto 2 dimensions in a dimensionality 2 map 206. The correspondence between sets of original dimensions and each of the projected dimensions is depicted. Peripheral and center parts of the image (which correspond to almost empty pixel values) are collapsed together into one projected dimension, D1. Similarly centrally located portions of the image are also grouped together to form the second dimension, D2. While this example illustrates the usefulness of the present dimension grouping techniques for image/multimedia data, it should be understood that the present principles have utility in a number of other domains. Examples of such domains are illustratively described.

1. High-dimensional data visualization: The present embodiments may perform an intelligent grouping of related dimensions, leading to an efficient low-dimensional interpretation and visualization of the original data. The present embodiments provide a direct mapping from the low-dimensional space to the original dimensions, permitting more coherent interpretation and decision making based on the low-dimensional mapping (contrast this with other system (e.g., Principal Component Analysis (PCA)), where the projected dimensions are not readily interpretable, since they involve translation and rotation on the original attributes).

2. Gene expression data analysis: Microarray analysis provides an expedient way of measuring the expression levels for a set of genes under different regulatory conditions. They are therefore very important for identifying interesting connections between genes or attributes for a given experiment. Gene expression data are typically organized as matrices, where the rows correspond to genes and columns to attributes/conditions. The present embodiments could be used to mine either conditions that collectively affect the state of a gene or, conversely, sets of genes that are expressed in a similar way (and therefore may jointly affect certain variables of the examined disease or condition).

3. Recommendation systems: An increasing number of companies or online stores use collaborative filtering to provide refined recommendations, based on historical user preferences. Utilizing common/similar choices between groups of users, companies like AMAZON™ or NETFLIX™ can provide suggestions on products (or movies, respectively) that are tailored to the interests of each individual customer. For example, NETFLIX™ serves approximately 3 million subscribers providing online rentals for 60,000 movies. By expressing rental patterns of customers as an array of customers versus movie rentals, the present principles could then be used for identifying groups of related movies based on the historical feedback.

In the following sections, a more detailed description of the methodology for data reorganization will be provided. TABLE 1 includes symbol names and description that will be employed throughout this description.

TABLE 1
Description of main notation.

| SYMBOL | DESCRIPTION | SYMBOL | DESCRIPTION |
|---|---|---|---|
| N | Database size | [symbol] | An ordering of all D |
| | (number of points). | | dimensions. |
| D | Database | K | Number of dimension |
| | dimensionality. | | partitions. |
| t₁ | Tuples | [symbol] | Set of partition |
| | row vectors), tᵢ∈ R^{D}. | | breakpoints. |
| t₁(d) | The d-th | [symbol] | The k-th ordered |
| | coordinate of tᵢ. | | partition. |
| T | Database, as an | Dₖ | Size of [symbol] . |
| | N × D matrix. | | |

Assuming a database T that includes N points (rows) in D dimensions (columns), the goal is to reorder and partition the dimensions into K segments, K<D. Denote the database tuples row vectors t₁ ε R^{D}, for 1≦i≦N. The d-th value of the i-th tuple is t₁(d), for 1≦d≦D. Begin by first defining an ordered partitioning of the dimensions. Then, introduce measures that characterize the quality of a partitioning, irrespective of order. Then, reordering can be exploited to find the partitions efficiently, with a single pass over the database.

Definition 1: (Ordered partitioning (D, B). Let D≡(di, . . . , d_{D}) be a total ordering of all D dimensions. The order along with a set of breakpoints B=(b₀, b₁, . . . , b_{K-1}, b_{K}) defines an ordered partitioning, which divides the dimensions into K segments (by definition , b₀=1 and b_{K}=D+1 always). The size of each segment is Dₖ=bₖ−bₖ₋₁. Denote by Dₖ (d_{k,1}, . . . , d_{k,DK}) the portion of D from positions bₖ₋₁ up to bₖ, i.e., d_{k,j}≡d_{j-1+bk-1}, for 1≦j≦Dₖ.

A measure of quality is needed. Given a partitioning, consider a single point tᵢ. Ideally, a smallest possible variation among values of tᵢ within each partition Dₖ is desirable.

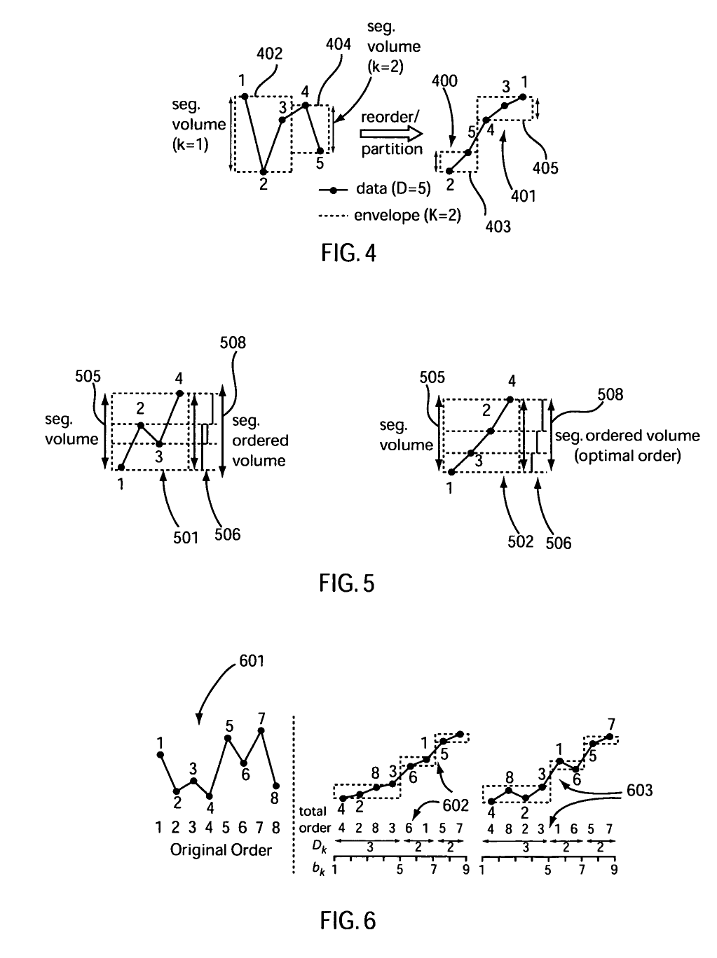

Referring to FIG. 4, K-dimensional envelopes 402, 404 and 403, 405 of D-dimensional points (labeled 1-5) are illustratively shown. Two different partitions 400 and 401 and their corresponding envelopes 403 and 405 (dashed lines) include the minimum and maximum values of tᵢ within each set of dimensions Dₖ. The partition 400 has a smaller volume.

The reordered dimensions 1-5 for partitions 400 and 401 is D=(2,5,4,3,1) with breakpoints B=(1,3,6) and partition sizes are D₁=3−1=2 for envelope 403 and D₂=6−3=3 for envelope 405.

Definition 2 (Envelope volume vᵢ(D, B)). The envelope volume of a point tᵢ, 1≦i≦N is defined by:

$${v}_{i} ( 𝒟 , ℬ ) = {\sum }_{k = 1}^{K} ( {max}_{d ∈} 𝒟 k {t}_{i} ( d ) - {min}_{d ∈} 𝒟 k {t}_{i} ( d ) ) .$$

### This is proportional to the average (over partitions) envelope width.

Definition 3 (Total volume V(D, B)). The total volume achieved by a partitioning is

$$v ( 𝒟 , ℬ ) = {\sum }_{i = 1}^{N} {v}_{i} ( 𝒟 , ℬ ) .$$

It should be understood that although the width of an envelope segment Dₖ is related to the variance within that partition, the envelope volume vᵢ is different from the variance (over dimensions) of tᵢ. Furthermore, the total volume V is not related to the vector-valued variance of all points, and hence is also not related to the per-column variance of T.

Summarizing, a single partitioning of the dimensions is sought for an entire database. To that end, it would be desirable to minimize the total volume V.

The notions of an ordered partitioning and of volume have been defined. Unfortunately, summation over all database points in V is the outermost operation. Hence, computing or updating the value of V would need buffer space kN for the minimum values and another kN for the maximum values, as well as O(N) time. Since N is very large, direct use of V to find the partitioning may not be feasible. Surprisingly, by intelligently using the dimension ordering, the problem can be recast in a way that permits performing a search after a single pass over the database. The reordering of dimensions may be chosen to maximize some notion of “aggregate smoothness” and serve at least two purposes: (i) provide an accurate estimate of the volume V that does not require O(N) space and time, and (ii) locate the partition breakpoints. The following description provides additional clarity to these concepts.

Referring to FIG. 5, an ordered volume for data points within a segment is illustratively shown (for a segment shown as the first segment in FIG. 6). Two volumes are depicted. Volume 501 is a non-optimal order (the “true” segment volume is not equal to a segment ordered volume). Volume 502 is in optimal order where the segment volume equals the segment order volume (see Lemma 1), and the ordered volume equals the “true” volume.

Volume through ordering: Consider a point tᵢ and a partition Dₖ. Instead, of the difference between the minimum and maximum over all values tᵢ(d) for d ε Dₖ, consider the sum of differences between consecutive values in Dₖ.

Definition 4 (Ordered envelope volume v̅ᵢ (D, B). The ordered envelope volume of a point tᵢ, 1≦i≦N is defined by

$${\overline{v}}_{i} ( 𝒟 , ℬ ) = {\sum }_{k = 1}^{K} {\sum }_{j = 2}^{{D}_{k}} \vert {t}_{i} ( {d}_{k , j} ) - {t}_{i} ( {d}_{k , j - 1} ) \vert = {\sum }_{j = 1 \\ j ∉ B}^{D} \vert {t}_{i} ( {d}_{j} ) - {t}_{i} ( {d}_{j - 1} ) \vert .$$

FIG. 5 shows the ordered volumes of two different dimension orderings in one segment. Thin double arrows 505 show the segment's volume, and thick lines 506 on the right margin show the consecutive value differences. Their sum is the segment's ordered volume (thick double arrow 508).

Lemma 1 (Ordered volume). For any ordering D, vᵢ (D, B)≦ v̅ᵢ (D, B). Furthermore, holding B fixed, there exists an ordering D* for which the above holds as an equality, v̅ᵢ (D,B)=vᵢ (D,B) .

The order D* for which the ordered volume matches the original envelope volume of any point tᵢ is obtained by sorting the values of tᵢ in ascending (or descending) order. The full proof is omitted.

Referring to FIG. 6, one point 601 and two total orders 602 and 603 that correspond to the same partitioning (D=7 and K=3) are shown. The breakpoints bₖ, 0≦k≦K are also shown, along with the induced partition sizes Dₖ, 1≦k≦K. The total ordering serves two purposes: first, to make the ordered volume within individual partitions close to the “true” volume, and second, to assist in finding the best breakpoints, which minimize the envelope and total volumes. An original order 601 provides eight consecutive dimension points 1-8. The original order 601 is reordered in orders 602 and 603. The first reordering 602 minimizes a sum of consecutive value differences, and achieves both goals as described above.

Definition 5 (Total ordered volume). The total ordered volume achieved by a partitioning is

$$\overline{V} ( 𝒟 , ℬ ) = {\sum }_{i = 1}^{N} {v}_{i} ( 𝒟 , ℬ ) .$$

Lemma 1 states that, for a given point tᵢ, the ordering D permits estimation of the envelope volume using the sum of consecutive value differences. Furthermore, using a similar argument, it can be shown that a reordering D also helps to find the best breakpoints for a single point, i.e., the ones that minimize its envelope volume (see FIG. 6).

Lemma 2 (Envelope breakpoints). Let D*≡(d₁, . . . , d_{D}) be the ordering of the values of tᵢ in ascending (or descending) order. Given D*, let the breakpoints b₁, . . . , b_{K-1} be the set of indices j of the top-(K−1) consecutive value differences |tᵢ(dⱼ)−tᵢ(dⱼ₋₁)| for 2≦j≦D. Then, vᵢ (D*,B*)= v̅ᵢ (D*,B*) and this is the minimum possible envelope volume over all partitioning (D,B).

Rewriting the volume: Optimizing for V̅, instead of V, can be performed with only a single pass over the database. By substituting the minimum and maximum operations (in vᵢ) with a summation (in v̅ᵢ), it is possible to exchange the summation order and make the summation over all points the innermost one. This permits us to compute this quantity once, hence needing only a single scan of the database. First, a name, dimension distance, is given to this sum.

Definition 6 (Dimension distance). For any pair of dimensions, 1≦d, d′≦D, their dimension distance is the L¹-distance between the d-th and d′-th columns of the database T, i.e.,

$$Δ ( d , {d}^{′} ) = {\sum }_{i = 1}^{N} \vert {t}_{i} ( d ) - {t}_{i} ( {d}^{′} ) \vert ..$$

The dimension distance is similar to the consecutive value difference for a single point, except that it is aggregated over all points in the database. If some of the dimensions have similar values and are correlated, then their dimension distance is expected to behave similarly to the differences of individual points and have a small value. If, however, dimensions are uncorrelated, their dimension distance is expected to be much larger. Now, the expression for V(V, B) can be rewritten:

$$\overline{V} ( 𝒟 , ℬ ) = {\sum }_{i = 1}^{N} {\sum }_{j = 1 \\ j ∉ B}^{D} \vert {t}_{i} ( {d}_{j} ) - {t}_{i} ( {d}_{j - 1} ) \vert = {\sum }_{j = 2 \\ j ∉ B}^{D} Δ ( {d}_{j} - {d}_{j - 1} ) . \qquad ( 1 )$$

Partitioning with traveling salesman problem (TSP): With multiple points, a simple sorting can no longer be used to find the optimal ordering and breakpoints. However, as observed before, sorting the values in ascending (or descending) order is equivalent to finding the order that minimizes the envelope volume and an optimum of V̅ can still be found. As explained in Definition 6, the dimension distance can be expected to behave similarly to the individual differences. It should be small for dimensions with related values and large for uncorrelated dimensions.

Instead of optimizing simultaneously for D and B, first optimize for D and subsequently choose the breakpoints in a fashion similar to Lemma 2. Therefore, an objective function C(D) is similar to Equation (1), except that it also includes dimension distances across potential breakpoints.

Definition 7 (TSP objective). Optimize for a cost objective:

$$C ( 𝒟 ) = {\sum }_{j = 2}^{D} Δ ( {d}_{j} - {d}_{j - 1} ) . \qquad ( 2 )$$

### This formulation implies that Δ(d₁−d_{D})≧Δ(dⱼ−dⱼ₋₁), for 2≦j≦D.

If the last condition were not true, a simple cyclical permutation of D would achieve a lower cost. After finding D*=arg max_{D} C(D), the breakpoints are selected in a fashion similar to Lemma 2, by taking the indices of the top-(K−1) dimension distances Δ(dⱼ−dⱼ₋₁), for 2≦j≦D.

This simplification of optimizing first for D has the added benefit that different values of K can very quickly be tried. The objective of Equation (2) is that of the traveling salesman problem (TSP), where nodes correspond to dimensions and edge lengths correspond to dimension distances.

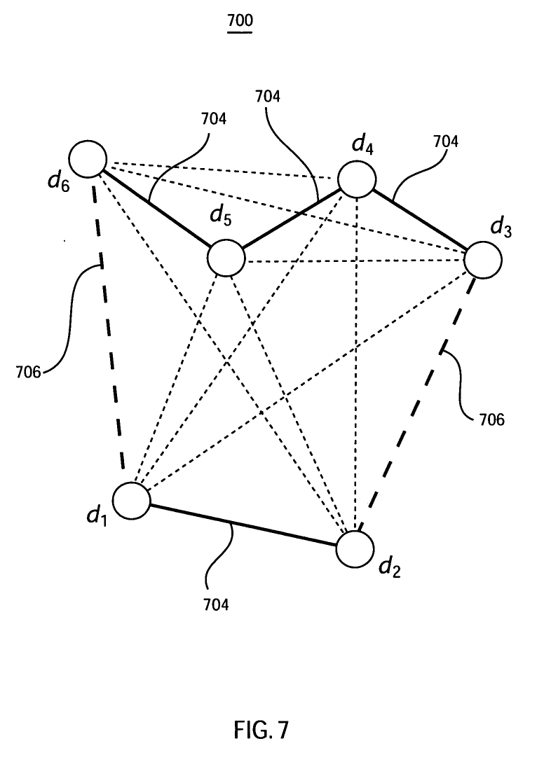

Referring to FIG. 7, a TSP tour or dimension graph 700 is illustratively shown with thick lines 704 between d nodes (dimensions) 1-6 showing dimension distances. Breakpoints (for K=2) are its two longest edges (dashed thick lines 706).

The dimensions d are ordered as an instance of a traveling salesman problem (TSP) applied to the dimension graph 700, where nodes d correspond to dimensions and edge weights correspond to respective dimension similarity. Reordering is obtained as an order of a TSP tour on the dimension graph, wherein segmenting is performed using the TSP tour such that break points (or segment ends or positions) correspond to edges with a largest weight (706) on the TSP tour 700.

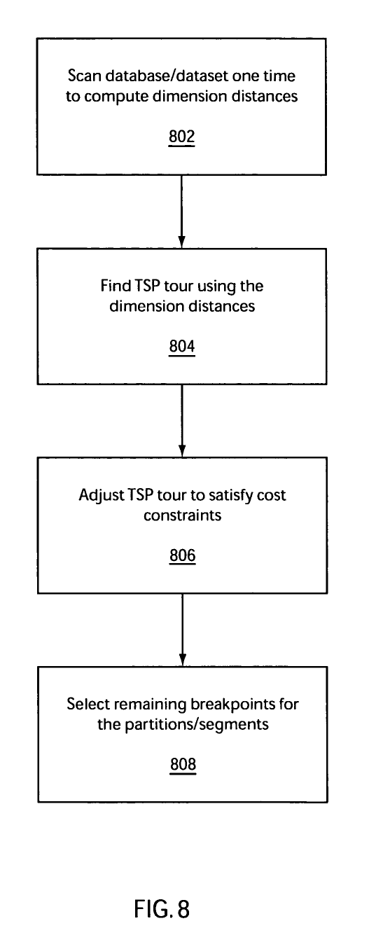

Referring to FIG. 8, a method for optimizing for D and B is illustratively shown in accordance with one embodiment. In block 802, scan a database once to compute the D×D matrix of dimension distances. In block 804, find a TSP tour D of the D dimensions, using the above distances (equation (2)). In block 806, if necessary, rotate the TSP tour to satisfy the condition in Definition 7. In block 808, choose the remaining K−1 breakpoints, in B, as described above.

The column reordering problem for binary matrices, which is a special case of the desired reordering for the presently addressed problem is already shown to be NP-hard. This means that we cannot find the optimal solution to this problem in reasonable (polynomial—with respect to the input size) time. The dimension distance Δ satisfies the triangle inequality, in which case a factor-2 optimal of C(D) can be found in polynomial time. In practice, even better solutions can be found quite efficiently (e.g., for D=100, typical running time for TSP using Concorde (see http://www.tsp.gatech.edu/concorde/) is about 3 seconds).

Indexing: how to find an ordered partitioning that makes the points as smooth as possible, with a single pass over the database has been outlined above. A natural choice for a low-dimensional representation of the points tᵢ is a per-partition average of its points. More precisely, map each tᵢ ε R^{D} into \hat{t}ᵢ ε R^{k} defined by:

$${\hat{t}}_{i} ( k ) = \frac{1}{{D}_{k}} {\sum }_{d ∈ {D}_{k}}^{ } {t}_{i} ( d ) ,$$

for 1≦k≦K.

Assume we want to index tᵢ with respect to an arbitrary L^{p} norm. For 1≦p≦∞, a lower-bounding norm (∥·∥_{lb(p)})on the low-dimensional representations tᵢ is defined as:

$${‖ {\hat{t}}_{i} ‖}_{lb ( p )} = {( {\sum }_{k = 1}^{K} {D}_{k} \cdot {\vert {\hat{t}}_{i} ( k ) \vert}^{p} )}^{\frac{1}{p}} , if p \neq ∞ , or {‖ {\hat{t}}_{i} ‖}_{lb ( ∞ )} = {‖ {\hat{t}}_{i} ‖}_{∞} , if p = ∞ .$$

That ∥·∥_{lb(p)} is a lower-bounding norm for the corresponding L^{p} norm on the original data tᵢ is a simple extension of theorems for equal-length partitions known in the art.

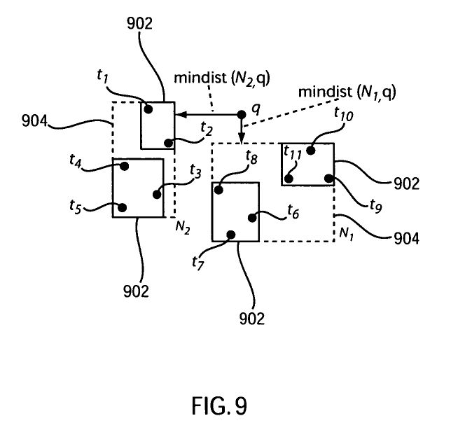

Referring to FIG. 9, an index \hat{t}ᵢ is used in a space partitioning index structure or tree (e.g., an R-tree) application as illustratively depicted in FIG. 9 for a simple 2 dimensional example. In this R-tree example, points t ₁-t₁₁ are recursively grouped into bounding boxes (nodes) 902 and 904. Boxes 904 include node volumes N₁ and N₂. A range query, q, prunes nodes based on the minimum possible distance (mindist) of the query points to any point included within a node. NN queries are processed by depth-first traversal and a priority queue, again using mindist. In other words, a minimum distance is determined from a query point to determine the best partitioning of the points. Since, ∥\hat{t}ᵢ∥_{lb(p)}≦∥\hat{t}ᵢ∥ₚ, computing mindist using ∥\hat{t}ᵢ∥_{lb(p)} guarantees no false dismissals, meaning that a search on the compressed data would return the same results as by scanning the original high-dimensional data. The partitioning (D, B) is chosen so as to make the segments as smooth as possible, therefore both the node volumes N₁ and N₂ in this example are expected to be small. Furthermore, it is precisely the smoothness that makes per-segment averages good summaries and ∥\hat{t}ᵢ∥_{lb(p)} good approximation of ∥\hat{t}ᵢ∥ₚ.

Experiments: Experiments conducted by the present inventors were performed in a plurality of applications. In one example, image data was employed. An example is provided to show the usefulness of the dimension reordering techniques for indexing and visualization.

In the experiment, the inventors utilized portions of the HHRECO symbol recognition database, which includes approximately 8000 shapes signed by 19 users.

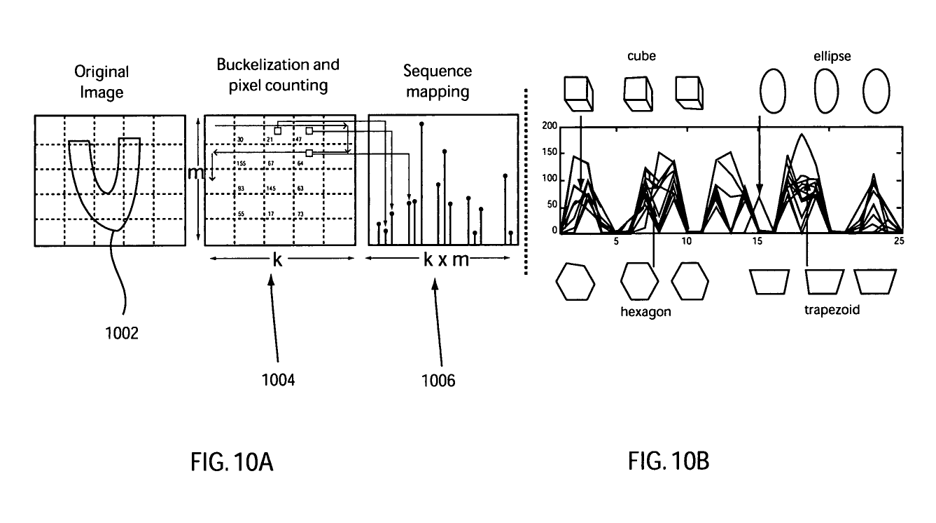

Referring to FIG. 10A, user strokes 1002 are rendered on screen and treated as images (200×150). Since it would be unrealistic to treat each image as 200-by-150 dimensional point, we performed a simple compaction of the image features as follows: by applying a k×m grid 1004 on the image, we recorded only k×m values which captured the number of pixels (pixel counting) falling into each bucket in a sequence mapping.

Using a 5×5 grid and starting from the top left image bucket, we followed a meander ordering and transformed each image into a 25-dimensional point in sequence mapping 1006. The exact bucket ordering technique at this stage is of little importance, since the dimensions are going to be reordered again by the present principles (therefore z- or diagonal ordering could have equally been used).

Referring to FIG. 10B, the originally derived 25D points for 12 images of the dataset are illustratively shown.

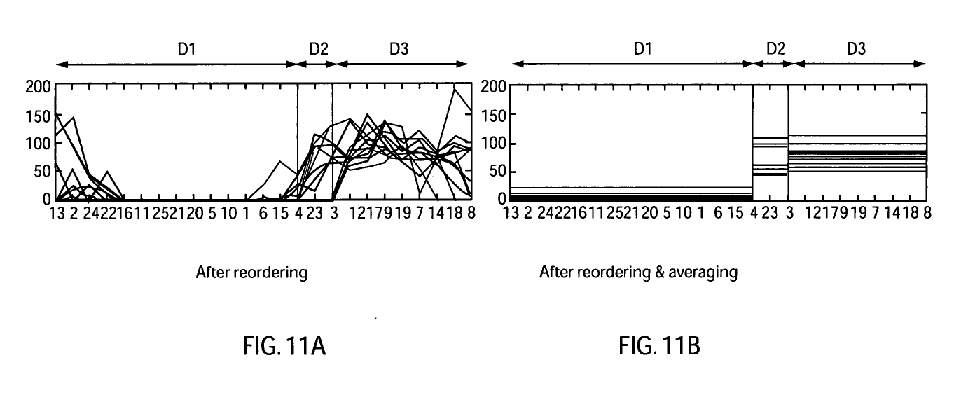

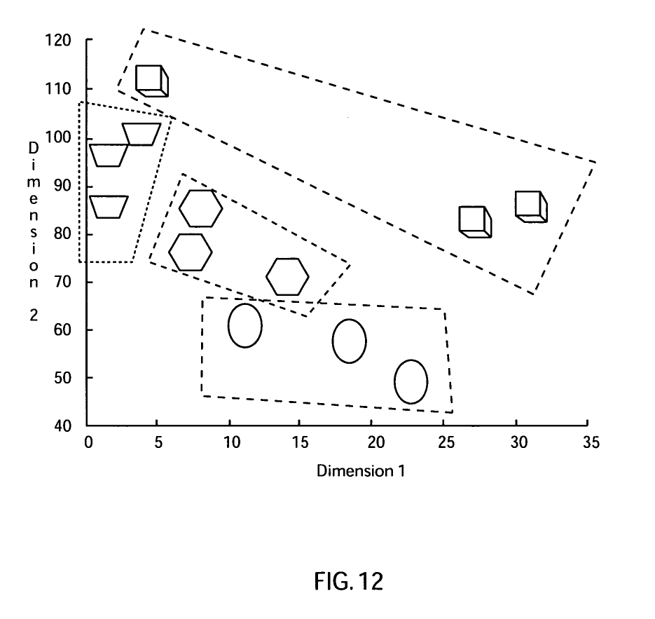

Referring to FIG. 11A, new sequences after the TSP-based reordering and also the grouping of dimensions into 3 segments (D₁, D₂ and D₃) are illustratively depicted. FIG. 11B illustrates the averaging per group of projected dimensions. New projected dimensions correspond to a group of the original dimensions. An average or representative value is assigned to each group and plotted in FIG. 11B. Plots on projected dimensions (like FIGS. 11A and 11B) can be very useful for summarizing and visualizing high-dimensional data. This mapping groups, reorders and summarizes dimensions. When the images are projected into 2 or 3 groups of dimensions, they can also be visualized in 2D or 3D. For example, by projecting the 25D points onto 2 dimensions and placing the 12 images at their summarized projected coordinates the mapping of FIG. 12 is achieved.

One can observe that relative distances are well preserved and similar-looking shapes (e.g., hexagons and circles) are projected in the vicinity of each other.

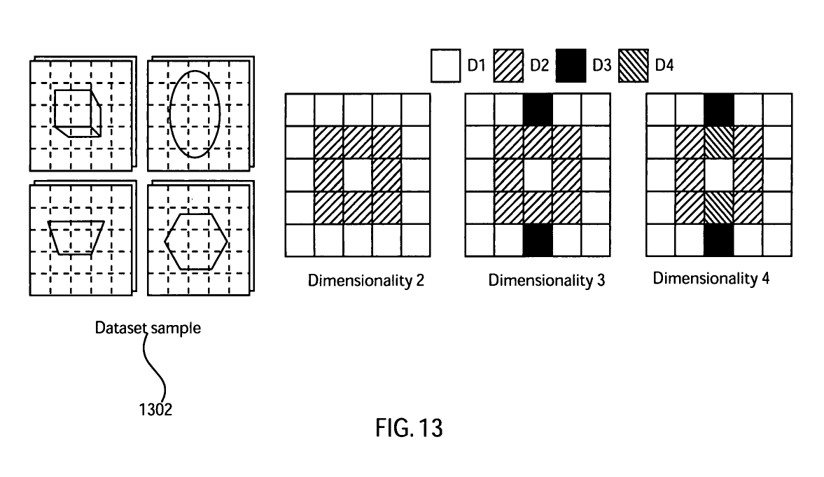

Referring to FIG. 13, correspondence between projected dimensions and portions of the image for projected dimensionalities of 2, 3 and 4 is illustratively depicted. An illustrative dataset sample 1302 has image regions projected into different groups or dimensionalities (D₁₋₄) which correspond to empty image space (D₁) (which is clustered together), while image portions that carry stroke information are grouped into different segments (D₂-D₄).

Application for Collaborative Filtering: The MOVIELENS™ database is utilized as a movie recommendation system. The database includes ratings for 1682 movies from 943 users. A smaller portion of the database was sampled including all the ratings for 250 random movies. The dimension (≡movies) reordering technique in accordance with present principles was applied. Indicative of the effective reordering is the measurement of the global smoothness, which is improved, since the cost function C that is optimized is minimized by a factor of 6.2. It was also observed that very meaningful groups of movies in the projected dimensions were achieved. For example, one of the groupings includes action blockbuster movies, while another grouping included action thriller movies.

Indexing with R-trees: the performance gains of the reordering and dimension grouping in accordance with the present principles are quantified on indexing structures (and specifically on R-trees). For this experiment, all the images of the HHRECO database were employed, but 50 random images were held out for querying purposes. Images were converted to high-dimensional points (as discussed above), using 9, 16, 36 and 64-dimensional features. These high-dimensional features were reduced down to 3, 4, 5, 6 and 8 dimensions using the present principles. The original high-dimensional data were indexed in an R-tree and their low-dimensional counterparts were also indexed in R-trees using the modified mindist function as previously discussed.

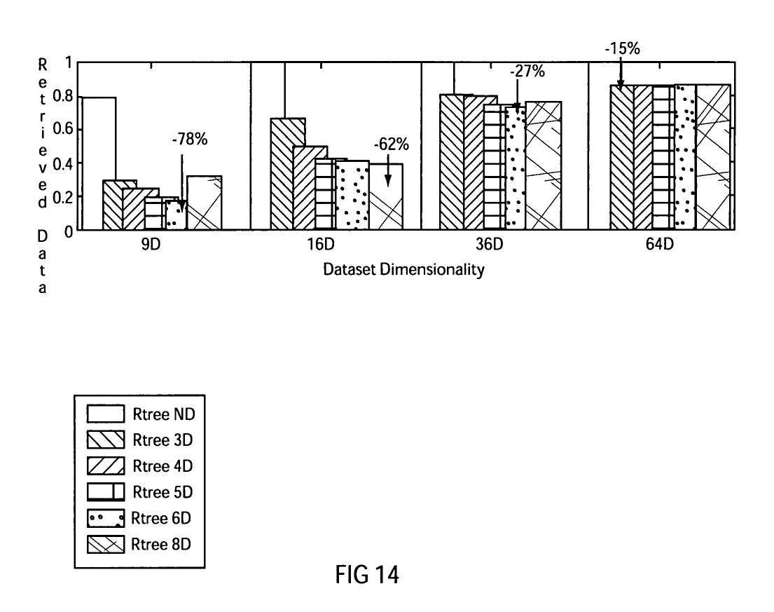

For each method, the amount of retrieved high-dimensional data was recorded, i.e., how many leaf records were accessed. FIG. 14 displays the results normalized by the total number of data. The R-tree on the original data exhibits very little pruning power which was expected, since it operates at high dimensionality. The results shown in FIG. 14 are for the new R-trees operating on the grouped dimensions and these new R-trees exhibit much higher efficiency for search performance. Notice that for 9D original dimensionality, the search performance can be improved by 78% in the best case, which happens for 6 grouped dimensions. For 16D data a projected group dimensionality of 8 is the one that gives the best results, which is 62% better than the pruning power of the original R-tree.

For even higher data dimensionalities, the gain from the dimension grouping diminishes slowly but one should bear in mind that the original R-tree already fetches approximately all of the data for dimensionalities higher than 16. A connection between the projected group dimensionality at which the R-tree operates most efficiently and the intrinsic data dimensionality can be made. Realization of such a connection can lead to more effective design of indexing techniques.

FIG. 14 shows savings induced by using the projected grouping techniques in conjunction with an R-tree structure. Data at various dimensionalities (x-axis) are projected down to 3, 4, 5, 6 and 8 dimensions. ND represents no dimensions.

Summarizing, the indexing experiments have demonstrated that the present methods can effectively enhance the pruning power of indexing techniques. The information has only been reorganized and packetized differently in the data dimensions, and has not been modified in the least in inner-workings or the structure of the R-tree index. Additionally, since there is a direct mapping between the grouped and original dimensions, the present methods have the additional benefit of enhanced interpretability of the results.

A new methodology for indexing and visualizing high-dimensional data has been presented. By expressing the data in a parallel coordinate system, an attempt to discover a dimension ordering that will provide a globally smooth data representation is provided. Such a data representation is expected to minimize data overlap and therefore enhance generic index performance as well as data visualization. The dimension reordering problem is solved by recasting the problem as an instance of the well-studied TSP problem. The results indicate that R-tree performance can reap significant benefits from this dimension reorganization.

Having described preferred embodiments of systems and methods for indexing and visualization of high-dimensional data via dimension reorderings (which are intended to be illustrative and not limiting), it is noted that modifications and variations can be made by persons skilled in the art in light of the above teachings. It is therefore to be understood that changes may be made in the particular embodiments disclosed which are within the scope and spirit of the invention as outlined by the appended claims. Having thus described aspects of the invention, with the details and particularity required by the patent laws, what is claimed and desired protected by Letters Patent is set forth in the appended claims.

What is claimed is:

1. A method for reordering dimensions of a multiple-dimensional dataset, comprising:
ordering dimensions of multi-dimensional dataset such that original D dimensions of the data are reordered to obtain a smooth sequence representation which includes placement of the D dimensions with similar behavior at adjacent positions in an ordered sequence representation; and
segmenting the ordered sequence representation into groups of K<D dimensions based on a break point criterion.

2. The method as recited in claim 1, wherein ordering and segmenting are achieved by performing a single pass over the dataset to collect global statistics.

3. The method as recited in claim 1, wherein segmenting includes partitioning the ordered sequence representation dimensions in a set of dimension groups, such that most similar dimensions are placed in a same group.

4. The method as recited in claim 3, further comprising utilizing the partitioning for identifying correlated/co-regulated attributes and for identification of a principal data axis.

5. The method as recited in claim 3, wherein each group includes data point values, and the method further comprises summarizing data point values of each data point within one dimension group using a single number to form a lower dimensional representation for each point.

6. The method as recited in claim 5, wherein summarizing includes averaging values in the dimensions of the group.

7. The method as recited in claim 1, further comprising indexing the groups of K<D dimensions using a multi-dimensional index structure.

8. The method as recited in claim 7, wherein the indexing structure includes a space partitioning tree.

9. The method as recited in claim 1, wherein the smooth sequence representation which includes placement of the D dimensions with similar behavior includes measuring similar behavior between dimensions using a distance measure.

10. The method as recited in claim 9, wherein the distance measure includes an L1-distance (a sum over all data points of an absolute difference of values of the data points in respective dimensions).

11. The method as recited in claim 1, wherein ordering includes ordering the dimensions as an instance of a traveling salesman problem (TSP) applied to a dimension graph, where nodes correspond to dimensions and edge weights correspond to respective dimension similarity.

12. The method as recited in claim 11, wherein reordering is obtained as an order of a TSP tour on the dimension graph.

13. The method as recited in claim 1, wherein segmenting is performed using a TSP tour on a dimension graph, such that segment positions correspond to edges with a largest weight on the TSP tour as the break point criterion.

14. The method as recited in claim 1, further comprising displaying the groups of K dimensions for visualization.

15. A computer program product for reordering dimensions of a multiple-dimensional dataset comprising a computer useable medium including a computer readable program, wherein the computer readable program when executed on a computer causes the computer to perform the steps of:
ordering dimensions of multi-dimensional dataset such that original D dimensions of the data are reordered to obtain a smooth sequence representation which includes placement of the D dimensions with similar behavior at adjacent positions in an ordered sequence representation; and
segmenting the ordered sequence representation into groups of K<D dimensions based on a break point criterion.

16. The computer program product as recited in claim 15, further comprising displaying the groups of K dimensions for visualization.

17. The computer program product as recited in claim 15, wherein each group includes data point values, and further comprising summarizing data point values of each data point within one dimension group using a single number to form a lower dimensional representation for each point.

18. The computer program product as recited in claim 15, wherein the smooth sequence representation which includes placement of the D dimensions with similar behavior includes measuring similar behavior between dimensions using a distance measure.

19. The computer program product as recited in claim 15, wherein ordering includes ordering the dimensions as an instance of a traveling salesman problem (TSP) applied to a dimension graph, where nodes correspond to dimensions and edge weights correspond to respective dimension similarity.

20. The computer program product as recited in claim 15, wherein reordering is obtained as an order of a TSP tour on the dimension graph, and segmenting is performed using a TSP tour on a dimension graph, such that segment positions correspond to edges with a largest weight on the TSP tour as the breakpoint criterion.
